(19) United States
(12) Patent Application Publication
(10) Pub. No.: US 2002/0099798 A1
(43) Pub. Date: Jul. 25, 2002

(54) File transfer method and system

(76) Inventors: Ruslan Gennadievich Fedorovsky, Amersham (GB); Peter Stuart Morris, High Wycombe (GB)

Correspondence Address: Steven J. Henry, Wolf, Greenfield & Sacks, P.C., 600 Atlantic Avenue, Boston, MA, 02210, US

(21) Appl. No.: 09/770,579

(22) Filed: Jan. 25, 2001

(30) Foreign Application Priority Data
Nov. 29, 2000 (GB) 0029123.7

(51) Int. Cl. G06F 15/16

(52) U.S. Cl. 709/219; 709/231; 709/247

(57) ABSTRACT

A file transfer method is disclosed in which in which a client (100) requests a file from a server (110) and the server (110) sends to the client (100) one or more data segments which data segments together constitute content of the requested file and additional content provided by a service provider. A benefit that may be provided by at least preferred embodiments is that a provider of download files, and in particular audio files, may add additional material such as advertising material to the download content. Targeting of the material to a particular user might be achieved by asking the user to provide information about their interests, and selecting for inclusion those advertisements that most closely accord with the user's a preferences. To reduce storage requirements, the server may store a virtual file reference for each user and construct a customised file dynamically.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates to a file transfer method and system and in preferred arrangements provides a personalized or individualized file transfer method and system.

### BACKGROUND

Many files are routinely transferred over a network (including the Internet) from a store of files on a server to a client. Conventionally, each file is of use to the client only when the entire file has been received. Moreover, it is normal that the same file will be requested many times, which means that the total file storage requirement of the server is not excessive in relation to the amount of network traffic.

In the case where a user is given the opportunity to download a large audio file, such as an audio book or a music album from a server in MP3 format, the user may wish to download the file in portions (typically, corresponding chapters of a book or to music tracks in an album). This is particularly so because the entire file may take considerable time to download over a low-bandwidth Internet connection that might typically be used by a home user.

### SUMMARY OF THE INVENTION

An aim of this invention is to provide a method and a system that allows a client to download from a server a virtual file that has been tailored to the client's (or, more precisely, a user thereof's) specific requirements, preferably in more than one download session If the user so chooses, while reducing as far as possible the storage requirements of the server.

Accordingly, from a first aspect, the invention provides a file transfer method in which a client requests a file from a server and the server sends to the client one or more data segments, which data segments together constitute content of the requested file and additional content provided by a service provider.

A benefit that may be provided by at least preferred embodiments of the invention arises where a provider of download files, and in particular audio files, may add additional material such as advertising material to the download content. Advertising is considered to be more effective if it is targeted towards a particular user. This might be achieved by asking the user to provide information about the user's interests, and selecting for inclusion those advertisements that most closely accord with a user's previously provided preferences. The issue is similar with other content such as entertainment materials (for example, music programs and video films), computer programs (such as computer games and software applications), text-files (such as books or other documents), and so forth. A consequence of this is that the aggregate content that a user downloads, including the requested content and selected advertisements, may be tailored to each particular user. Even if the number of users who are delivered each download configuration of requested content plus advertisements is relatively small, the number of possible combinations of content may be very large. If each possible download combination had to be stored on the server as an individual file, the storage requirements for the server would become large. The system can be thought of as being a multi-user individualised file sender.

At first sight, it might be thought that the storage requirement of the server could be reduced to a manageable level by creating a temporary individualised file on the server for each user. The service might then wait while this user downloaded this file and then immediately delete this file from the server. However, analysis pursuant to the invention reveals that this is not a viable solution as many of existing downloading clients (download managers) allow a user to pause a downloading process for an undetermined period, which might be as long as days or weeks, and then resume it at a later date. Therefore such temporary files would have to be maintained on the server for a sufficiently long length of time. For large numbers of users, this method would require very considerable storage space, which in many cases would be impracticable.

It might also be thought that the storage requirement of the server could be reduced to a manageable level by simply sending individualised additional content (such as advertisements) as a separate files without first concatenating them to requested content (such as audio book chapters). However, analysis pursuant to the invention reveals that this is not a viable solution as the majority of users would not necessarily download the additional content such as advertisements or would not play them back even if the downloading process were initiated automatically.

In embodiments of this invention, the server need not maintain a copy of each of the aggregate file of requested content plus additional material. Instead, the server need only maintain the one copy of each of the segments, typically as real server files. The server may return a virtual file reference and construct the data to be supplied in response to a download request “on the fly”.

The server can select those segments that, when taken together, constitute the entire content most appropriate for the client user. The content may then be sent to the user as a single virtual file or as several files. It will be noted that the entire downloaded file need not exist on the server; it need only store the segments (for example, as actual files on the server) from which the download is made up. However, the invention does not exclude the possibility that in certain embodiments it may be advantageous to create a copy of the entire file on the server (at least temporarily or which may be retained for some predetermined time) to reduce processing requirements of the server.

Another alternative to reduce the storage requirement of the server to a manageable level would be to provide users with a modified Downloading Manager. In such a case, when a user decides to download a file, such as an audio book, the modified Downloading Manager would be arranged to receive from information indicating what additional content (such as advertisements) should be provided to the user with the requested content. The Downloading Manager would then initiate downloading of the requested content (for example chapter-files of the book) and additional content (for example relevant advert-files) transparently. The Downloading Manager would also transparently concatenate requested and additional content on the user PC and present the user with content (for example chapter-files) that have additional content (for example advertisements) embedded therein, for example as indivisible part of chapter-files. This solution is a possible alternative which may be provided in an alternative aspect of the invention but has some drawbacks:

1. It requires users to install a new Downloading Manger just for such a site (this can be alleviated by having the download manager install online).

2. Some user devices might not have sufficient computing capabilities to perform the required tasks (e.g. WAP mobile phone, MP3 hi-fis with direct downloading facilities, etc.)

3. Sending chapters and advertisements as a separate files would significantly increase possibilities for an unauthorised person to create a filter program that would bypass the Downloading Manager and filter out additional content.

4. It is likely that in some formats, the requested content and additional content could not be easily concatenated together without complicated, processor-intensive and storage-intensive re-conversions. Some user personal computers or devices might not have sufficient computer resources to perform such a task.

5. Such a Downloading Manager has to be continuously supported, developed and modified in conjunction with constant and accelerating development of different operating systems used by various user devices.

In the case where additional content comprises advertisements which may change periodically, the case may arise where a user has paused a download containing an advertisement which has been replaced. Problems may arise if the real file corresponding to the old advertisement is simply replaced and the user attempts to resume the download. These can be tolerated or minimised simply by retaining old files on the server for a set length of time. However, advantageously, the server may maintain a register of real files required by existing download requests which have not been completed and to retain real files at least while so required.

In a typical embodiment, the content requested by the client includes audio encoded speech or music. For example, the file may be encoded in MPEG Layer 3 (MP3) format. However, the method can be applied to any file format that can encode the required content. Advantageously, the additional content is provided in a format identical to or compatible with the content requested by the client. In this way, all of the content can be brought together by the client or the server to constitute, or to simulate, a unified file.

In a method embodying the invention, segments may be subject to data compression prior to their being sent by the server to the client. The segments are typically then uncompressed by the client to restore them to their original format. Some files, in their native form, compress their data. MP3 files are a particular example. These files would not normally be further compressed in embodiments of the invention. Such compression may combine several segments (for example, several files) into one compressed archive. These files are then recovered by the user when the archive is uncompressed.

The additional content may be selected by the server by identifying the client and providing additional content that is appropriate for that user. If the user cannot be identified, default and/or random additional content may be supplied. More specifically, in preferred embodiments, prior to making a file transfer request, a user will be asked provide personal information (for example, in an enrolment procedure to gain initial access to the server), and that personal information is consulted in order to determine the additional content to be sent to the user. The personal information may be obtained by requesting the user complete a questionnaire. Such personal information may be stored in a user database for future retrieval.

A method embodying the invention may receive requests from a client and return data to the client using a network protocol. For example, the protocol may be hypertext transfer protocol (HTTP), wireless application protocol (WAP) or file transfer protocol (FTP). A particular advantage of this arrangement is that the client may be a conventional computer with Internet access or, in the case of the wireless application protocol, a WAP-enabled mobile communication device. In the case of hypertext transfer protocol, the method can typically operate over a proxy server or a firewall, and can also be accessed by a public access Internet terminal.

In a file transfer method embodying the invention a list of segments to be downloaded to fulfil a request may be constructed and stored in a download database (for example, as a list of real files on a server).

Advantageously, in a file transfer method embodying the invention, the server receives a request from the client, and the server assigns the request a unique request identifier. In many embodiments, a record of the request is then constructed in a database, the record being identified by the request identifier. In a typical method, the unique identifier can be used to construct a virtual URL from which the virtual file can be downloaded by the client; the virtual URL can then be returned by the server to the client. In such embodiments, part of the download reference may be used by software on the client as a local file store name for the downloaded file. For example, the reference may include a name of an audio file. This can help the user to identify the file that has been downloaded. The URL may include data to enable the client to perform error detection on the downloaded file, for example, by including a cyclic redundancy check code for the file.

In alternative embodiments, the server may returns to the client a list of identifiers that identify segments to be downloaded to provide the content requested by the user. For example, the identifiers may identify real files on the server. In such embodiments, the client subsequently requests the segments specified in the list.

Of particular advantage, in a file transfer method embodying the invention when a transfer is interrupted and subsequently resumed, on resumption, only those segments not previously sent to the client are then sent to the client. This allows a user to interrupt and resume a download with a minimum of duplicated data transfer. For example, a record may be kept (for instance, in the virtual file database) of the position in the virtual file to which a download has progressed, and, upon resumption, the download is re-started from that position.

It should also be noted that in a method embodying the invention the segments need not be sent to the client in a contiguous stream. There may be pauses in the data stream within or between segments.

In another arrangement, the client may store the received data on a data carrier, such as a tape, a memory card, or an optical or magnetic disc. This data carrier can then be conveyed to the user. Alternatively, the data may be downloaded directly to a user's computing device, such as a self-contained audio file player. In such embodiments, the client and the server may both be operated by a service provider. The client and the server may operate on a single computer. Typically, data is transferred to the data carrier upon receipt of a request from a user. Such a request may be conveyed by many alternative methods, including computer-based communication methods, telephone, fax or post.

From a second aspect, the invention provides a file transfer server system comprising receiving means to receive a request for a file from a server, storage means for storing content requested by a user and additional content, and sending means to send to the client a plurality of data segments in turn that together constitute content of the requested file and additional content provided by the server.

The receiving means of such a file transfer server system most typically communicates with a client over a network link using a network protocol, for example, hypertext transfer protocol (HTTP), wireless application protocol (WAP) or file transfer protocol (FTP). Naturally, many other protocols might also be used. Conveniently, the receiving means may be embodied within a web server.

A server embodying this aspect of the invention may further comprise data storage means for writing segments that constitute content of the requested file and additional content provided by the server to a data carrier. This allows the requested file to be written to a data carrier (such as a tape, a memory card, or an optical or magnetic disc), which can subsequently be conveyed to a user. Alternatively or additionally, the server may further include interface means for transferring segments that constitute content of the requested file and additional content provided by the server to a user's computing device, such as a portable music file player.

A file transfer server system embodying this aspect of the invention may include selection means for selecting those segments that, when taken together, constitute the entire content intended for the client. Typically, the selection means includes a dynamic file database. The dynamic file database may contain a record for each request, the record identifying the data segments to be sent to the client in order to meet the request. Moreover, the dynamic file database record may indicate the position within the virtual file to which a client download has progressed.

Advantageously, a file transfer server system embodying this aspect of the invention may include a user database. Such a user database might include a list of users and personal information that relates to each user.

In preferred embodiments, a file transfer server system includes a database server that manages the dynamic file database and/or the user database. The selection means may be embodied within the database server.

In preferred embodiments, the file transfer server system returns to the client a virtual URL from which the virtual file can be downloaded by the client. Subsequently, a request for data from the virtual URL may be handled by the sending means, which might conveniently be embodied within a file transfer server. In such embodiments, the file transfer server may communicate with the client using one of hypertext transfer protocol (HTTP), wireless application protocol (WAP) or file transfer protocol (FTP).

In alternative embodiments, the server returns to the client a list of identifiers that identify segments to be downloaded to provide the content requested by the user. For example, the identifiers may identify real files on the server.

Most typically, a file transfer server embodying this aspect of the invention is embodied by a computer system executing server software. Moreover, a file transfer server embodying this aspect of the invention typically operates in accordance with a method embodying the first aspect of the invention.

From a third aspect, the invention provides server software executable on a computer system to perform a method embodying the first aspect of the invention.

From a fourth aspect, the invention provides a download client comprising a computer system programmed to send a request to a file transfer server that embodies the second aspect of the invention. However, it should be noted that such a server, in many embodiments, can communicate with conventional network clients such as a web browser or a file transfer client that operates using FTP.

From a fifth aspect, the invention provides a method of operating a file transfer server optionally in accordance with the second aspect of the invention to respond to a request for a file comprising compiling a list of data segments to be sent in response to the request, which data segments together constitute content of the requested file and additional content provided by a service provider.

Such a method may further comprising a step of identifying a user making the request and selecting those segments that, when taken together, constitute the entire content most appropriate for the user. In such embodiments, prior to responding to a file transfer request from a user, the server may obtain personal information from the user, and that personal information is consulted in order to determine the additional content to be sent to the user. For example, the server may obtain personal information by requesting the user complete a questionnaire. Thereafter, the personal information may be stored in a user database for future retrieval.

Typically in a method embodying this aspect of the invention, the server receives requests from a client and returns data to the client using a network protocol, such as hypertext transfer protocol (HTTP), wireless application protocol (WAP) or file transfer protocol (FTP).

In a method of operating a file transfer server, when the server receives a request, the server may assign the request a unique request identifier. A record of the request may then be constructed in a database, the record being identified by the request identifier.

In embodiments according to the last-preceding paragraph, the unique identifier may then be used to construct a virtual URL from which a virtual file can be downloaded. The URL may then be returned by the server to a client. The URL may advantageously include a name of an audio file. Moreover, the URL may include data to enable the client to perform error detection on the downloaded file. (The URL effectively provides a reference to a virtual file. An application may refer to the virtual file by way of a hyperlink.)

A method according to this aspect of the invention may comprise a further step of subject to processing prior to there being sent to a client to bring them into accordance with a requested file specification.

Advantageously, in a method of operating a file transfer server, when a transfer is interrupted and subsequently resumed, on resumption, only those segments not previously sent to the client are then sent to the client. This may, for example, be implemented by a method in which a record is kept of the position in the virtual file to which a download has progressed, and, upon resumption, the download is re-started from that position.

### BRIEF DESCRIPTION OF THE DRAWINGS

An embodiment of the invention will now be described in detail, by way of example and with reference to the accompanying drawings, in which:

FIG. 1 is a diagram of a client and server system exchanging files by a method embodying the invention;

FIG. 2 is a flowchart of a first stage in a method in which a user requests a file for download by way of a method embodying the invention;

FIG. 3 is a flowchart of a method by which the size of a dynamic file can be calculated;

FIG. 4 is a flowchart of a method by which a download interrupted by the user can be resumed;

FIG. 5 is a flowchart of a method by which a virtual file can be retrieved from the system database;

FIG. 6 is a flowchart of a method by which a virtual file can be opened by a client;

FIG. 7 is a flowchart of a method by which a seek operation can be performed within a virtual file; and

FIG. 8 is a flowchart of a method by which a virtual file can be transferred to a client;

### DETAILED DESCRIPTION

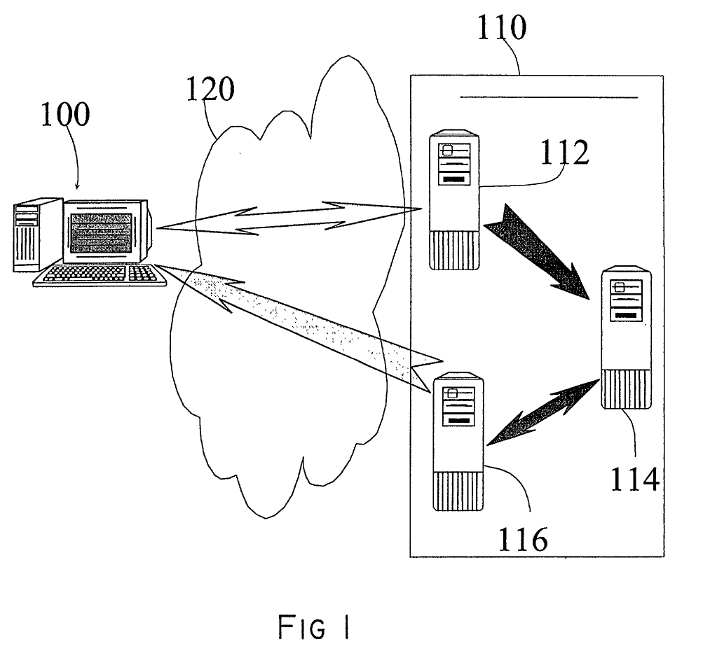

In FIG. 1, a client system is represented at 100, and the server system at 110. The server system 110 includes a web server 112, a database server 114 and a file transfer server 116. The client system 100 and the server system 110 are interconnected by a network link 120, which typically includes the Internet.

In this embodiment, the actions (preferably, but not necessarily in this order) that result in a file being delivered to a user are as follows:

1. A user registers with a service that provides audio files (for example, audio books) for download. As part of the registration process, the user is asked to provide the service provider with information about their demographics, preferences and interests. (Note that this will typically happen only once, before the first time that the user accesses the service.)

2. The user selects content, for example an audio book, to download on the basis of a selection presented in the web site (Step 210). Through a web browser, a user's client computer 100 sends a request for the selected file to a web server 112 over the network link 120.

3. The web server 112 returns a unique download reference to the client computer 100 at Step 212. The web server 112 also sends details of the request to the database server 114. This reference is used as an index to a unique database entry (Step 222).

4. The database server 114 generates database entry (Step 222) in a dynamic file database 230 and creates in that entry a list of content segments, each of which is an actual file on the file transfer server 116, that are required to fulfil the user's request (step 224), and sends the list to the file transfer server 116 (Step 226). The content segments include the content specifically requested by the user, together with additional content selected by the database server 114. Such additional content includes audio advertisements to include within the audio book download, targeted at the user's specific interests, demographics etc.

5. The web server 112 returns a URL to the client that includes the unique download reference (Step 232). The URL serves as a reference to a virtual file that the client can download.

6. The file transfer server 116 sends the segments to the client over the network link 120 or the transfer server writes data to a data carrier by means of a device (such as a disc drive or a tape drive) connected to the server 116 or connected to another computer, or downloads the file to a portable computing device.

7. The client may stop the download of the file at any point, and resume the download at a future date when it is more appropriate for the user.

It should be understood that the web server 112, the database server 114 and the file transfer server 116 need not be implemented as separate server computers. They could be implemented as separate processes executing on one computer or as a single software system executing on one computer. Equally, they could be distributed over separate computer systems, possibly at remote locations.

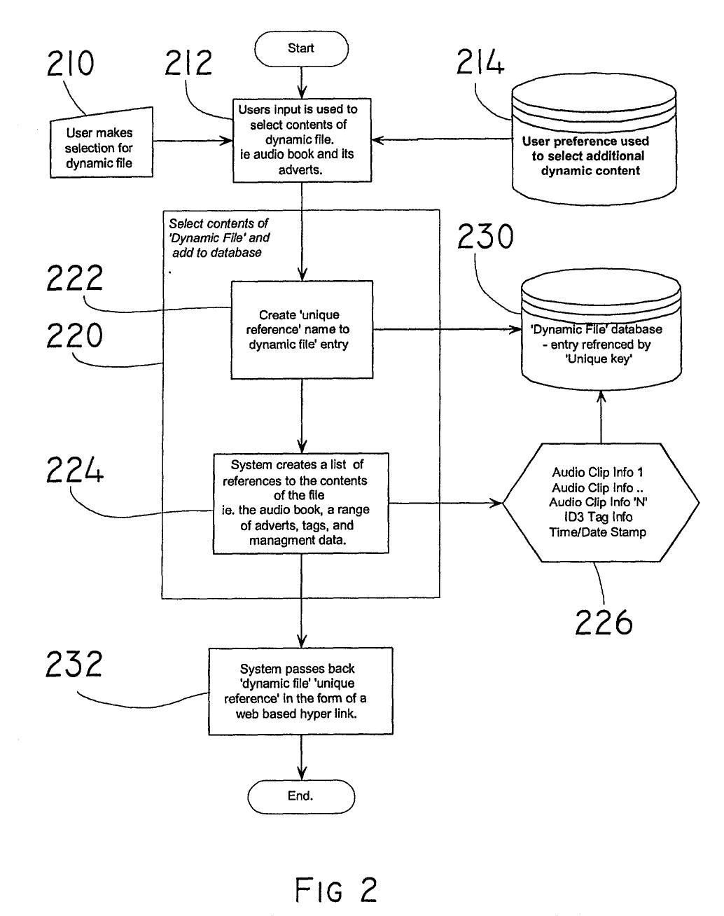

Aspects of the above method will now be discussed in further detail with reference to the flowcharts of FIGS. 2 to 8.

First, with reference to the section marked 220 in FIG. 2, when an entry in the database 230 is created, it is indexed by a unique key. This key contains characters compatible with the URL specification. The key may also have encoded into it a checksum or CRC (cyclic-redundancy-check) and will be used to verify the key is genuine. The relationship between the URL and the key should be calculated in a way that is not obvious to an outside observer in order that it should not be a straightforward matter for a person to guess a valid URL.

Database accesses are CPU and disk intensive. If the database were consulted every time a download request was received by the system, a malicious person could make a large number of invalid download attempts to mount a “denial of service” attack on the system. If the URL contains a CRC code, a checksum or other error-checking code, the URL can first be checked for internal validity before the database is inspected.

An error-checking code (such as a CRC code) for the entire virtual file can also be calculated and incorporated into the URL. Prior to downloading data to the client, the code can be re-calculated from data within the server files. If this does not agree with the code in the URL, the content of the files on the server has changed. Appropriate action can then be taken to ensure that incorrect data is not sent to the client.

This key will then be used to generate the URL defining the access to the file, and will be in this format—this ‘Unique URL’; it will never be repeated for different files.

<Unique URL> = <FTP or HTTP>://<DNS or IP address>/<optional fixed
path/><unique path>

The <unique path> can be either of two formats:

1) Form 1.

<unique path> := <unique key>/<filename>

e.g.

FTP://somewhere.net/fixedpath/a8283kjh2y7/someaudiobook.mp3

This results in the downloaded file being named ‘someaudiobook.mp3’.

1) Form 2.

<unique path> := <unique key> <filename extension e.g. “.MP3”>
e.g.
HTTP://somewhere.net/a8283kjh2y7.mp3

This results in the downloaded file being named ‘a8283kjh2y7.mp3’.

Form 1 may be easier for a human user to understand, but the Form 2 may be more appropriate for automatic storage by another computer.

Form 1 of the unique URL may be extended to support virtual storage directories. Form 1 also has an advantage in that this ‘unique path’ up to the ‘unique key’ (e.g. FTP://somewhere.net/fixedpath/a8283kjh2y7/) describes a directory store, and hence can be used to present a virtual directory containing a list of dynamic files. This virtual dynamic file storage directory can then be presented by the FTP, WAP or HTTP server as a directory and such can be listed and separate files downloaded.

A standard FTP client could result in this example output: (Server in normal text, client in bold)

OPEN somewhere.net
Username: anonymous
Password: guest
Okay
DIR

| | |
|---|---|
| fixedpath | <Dir> |

Okay.
CD fixedpath
Okay.
DIR
Permission denied.
CD a8283kjh2y7
Okay.
DIR

| | |
|---|---|
| someaudiobook.mp3 | 9,272,394 bytes |
| someaudiobook2.mp3 | 10,134,292 bytes |
| someaudiobook3.mp3 | 5,230,028 bytes. |

Okay.
GET someaudiobook2.mp3
File ‘someaudiobook2.mp3’ downloaded successfully.
QUIT

Notice the italic section towards the middle of this listing: until the unique path is specified, the directory cannot be listed. This is because the unique paths could be too numerous to list. It can also enhance security of the system.

In the final DIR section, the contents of the audio book, split into sections is listed, and the file ‘audiobook2.mp3’ file is downloaded, but at no point does the file or directory itself need to exist on the file store.

In this case the ‘unique key’ indexes a database record that contains a lists of references to multiple content descriptions of each virtual files.

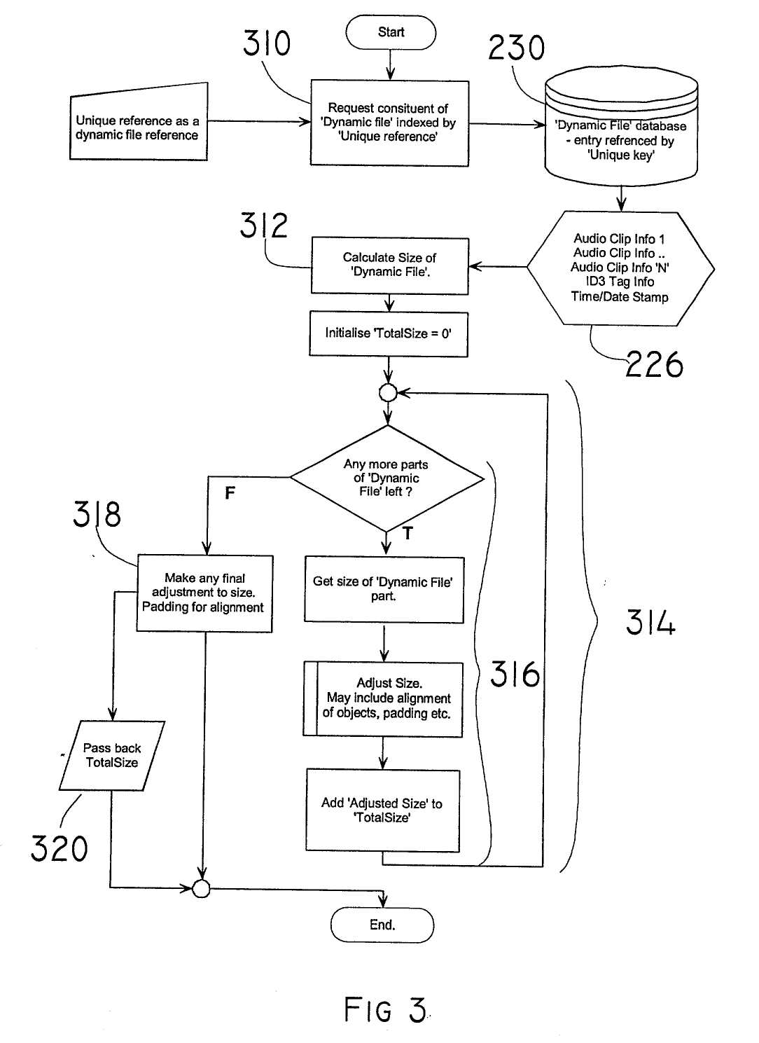

The process by which the size of a dynamic file can be calculated is illustrated in the flowchart of FIG. 3.

The size of the dynamic file is obtained by requesting details of all segments of the dynamic file (Step 310) from the dynamic file database 230 using the download reference as a database key. The system then calculates the size of the file (Step 312). This is achieved in a loop 314 and summing the sizes of all the constituent parts including alignment adjustments for the destined output format 316. For example, if the data was bit-aligned rather than byte-aligned, or adding additional formatting data and rounding up the size if necessary, and so forth. In the case of MP3 frame data, no alignment is typically necessary. Finally, any overall adjustment to the file size is made (Step 318) that might, for example, be inherent to the requested file format before the calculated size is returned to the requestor (Step 320).

Once the virtual file size has been calculated, the value may be stored in the dynamic file database 230. This can avoid the need to re-calculate the size when it is next required, and can also be used to verify that the file size has not been changed once it has first been calculated.

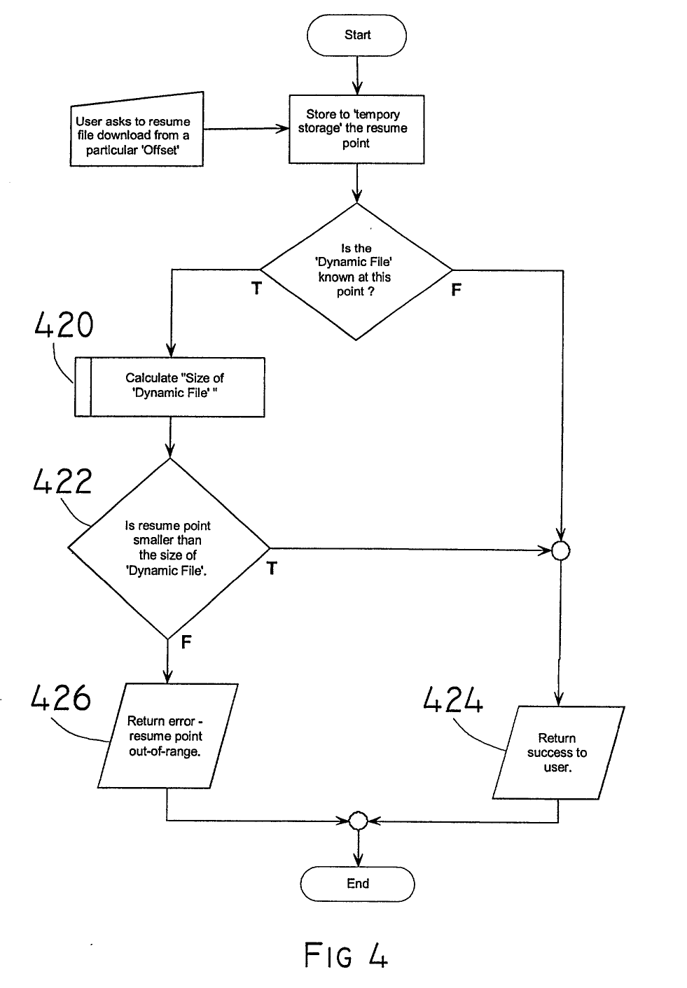

With reference to FIG. 4, during download of a virtual file by a client, a value that specifies the current point in the file that the download has reached (for example, a byte offset within the dynamic file) is stored in the database record of the associated request. This enables resumption of an interrupted download.

If the client has previously downloaded part of the virtual file, it may specify a resume point at which subsequent downloading is to be recommenced. If the dynamic file is known, the resume point can be checked whether it is inside the range of the file. This function is necessary for the file download to be resumed from an existing download point and the download continued.

In the case of an FTP download, the resume point is specified before the file to download, and as such cannot be checked until the file is requested, hence the check the resume point ‘Retrieve Dynamic File’.

In alternative embodiments, the resume point may be specified with the file and checked at this point.

Otherwise, the size of the dynamic file is calculated (Step 420) as described above, and this value is compared with the resume point value (Step 422). If the resume point value indicates a position beyond the end of the dynamic file, the client is informed that a download can successfully be resumed (Step 424). Otherwise, the request is terminated with a suitable error message (Step 426).

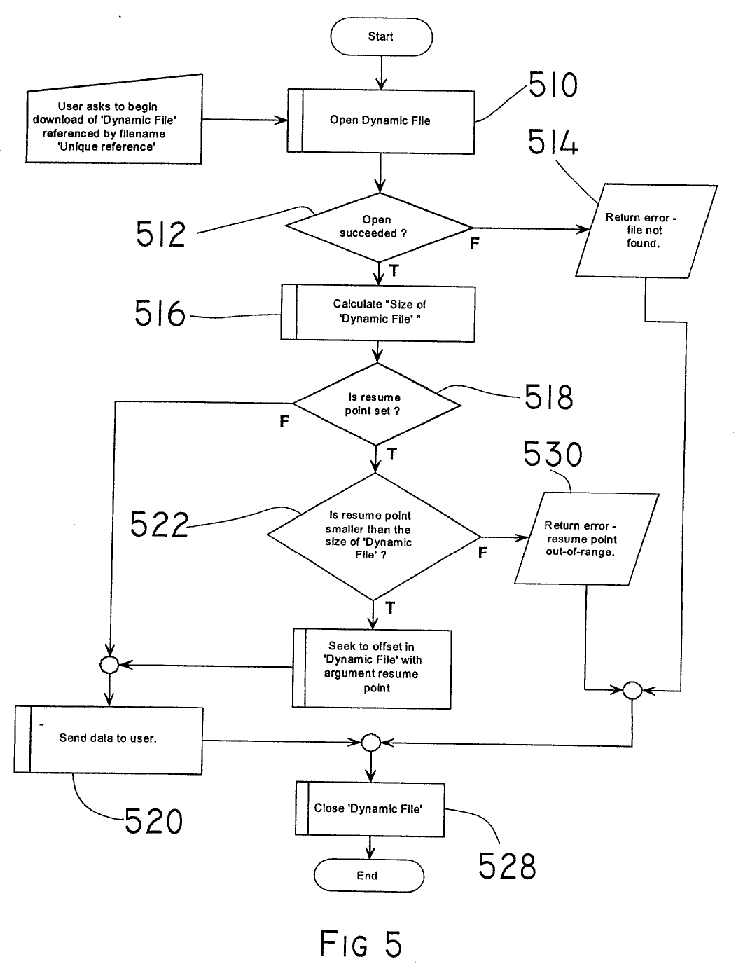

FIG. 5 shows the steps carried out when the dynamic file is requested, and opened by means of its unique reference. First, an open request is made to the dynamic file database 230. This operation is checked for success (Step 512). If it has failed, then an error is generated (Step 514).

Next, the dynamic file size is calculated (Step 516) and the system determines whether a resume point has been set for the file (Step 518). If the resume point has not been set the file is transmitted (Step 520) from the start. If a resume point is specified then the resume point is checked to be valid, and if so then the dynamic file seeks to a specified offset within the set of files (otherwise, an error condition is raised 530). The data is then delivered to the client until either the transfer of data is finished, or the operation is cancelled (Step 520). The dynamic file is then closed (Step 528).

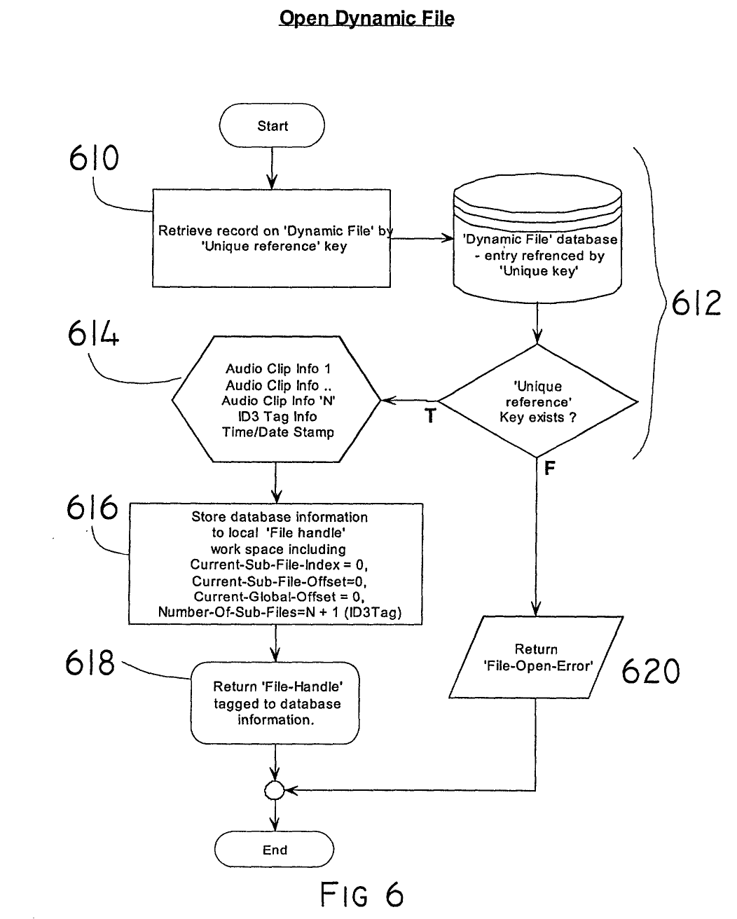

With reference to FIG. 6, to download a file, the client sends a request that includes the unique URL, which is received by the transfer server 116 (Step 610). The corresponding unique key can be determined from the open request. This key is used by the transfer server 116 to request the contents of the dynamic file from the database as a list 614 of its constituent parts (Step 612). This information is then stored with a file and is used later to recreate the data had the file actually existed (Step 616). If successful a dynamic file handle identifier is returned (Step 618). If unsuccessful a error is returned (Step 620)—this would be reported to back to the file transfer, for example, by sending a “File not found.” Message.

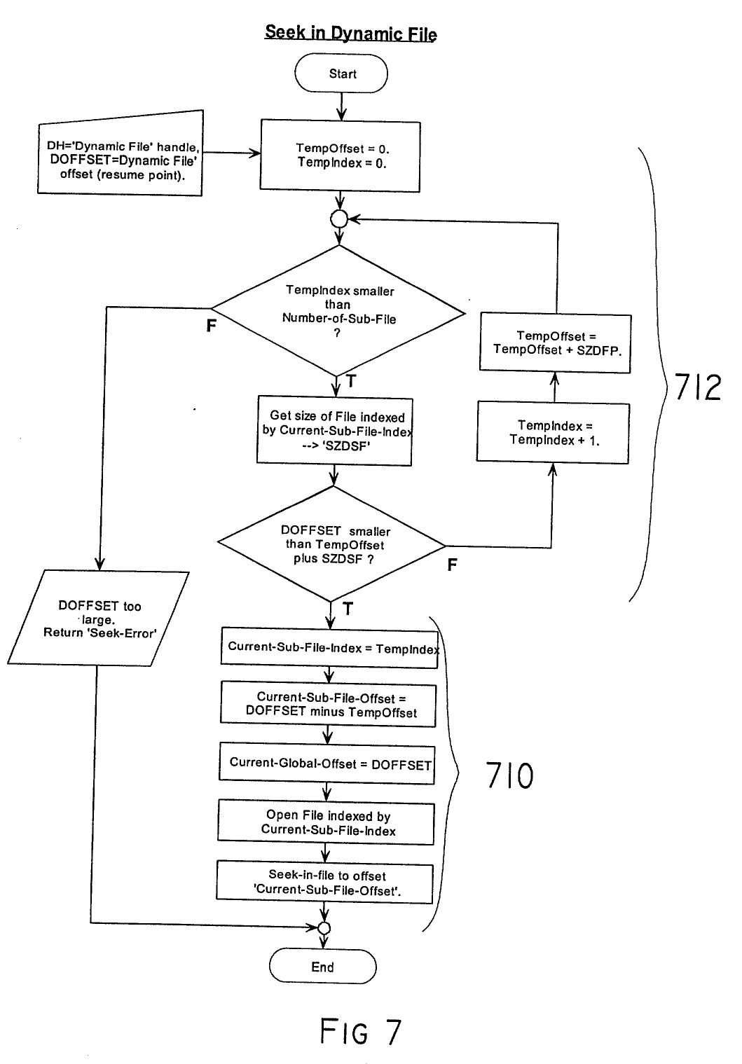

A procedure which may be followed to perform a seek in a dynamic file is shown in FIG. 7. The opened file handle to the dynamic file is adjusted to a new byte offset within the dynamic file, so reading data from the dynamic file handle would match the data at the supplied offset had the file existed as a real file. As noted above the offset must take into account any adjustments for alignment of data, and additional formatting data, or if near the end of the file any padding data. The offset within the virtual file is converted to an offset within a segment (referred to also as a “sub-file”) at step 710, having first skipped those sub-files that are positioned in the virtual file entirely before the offset within the dynamic file (Step 712).

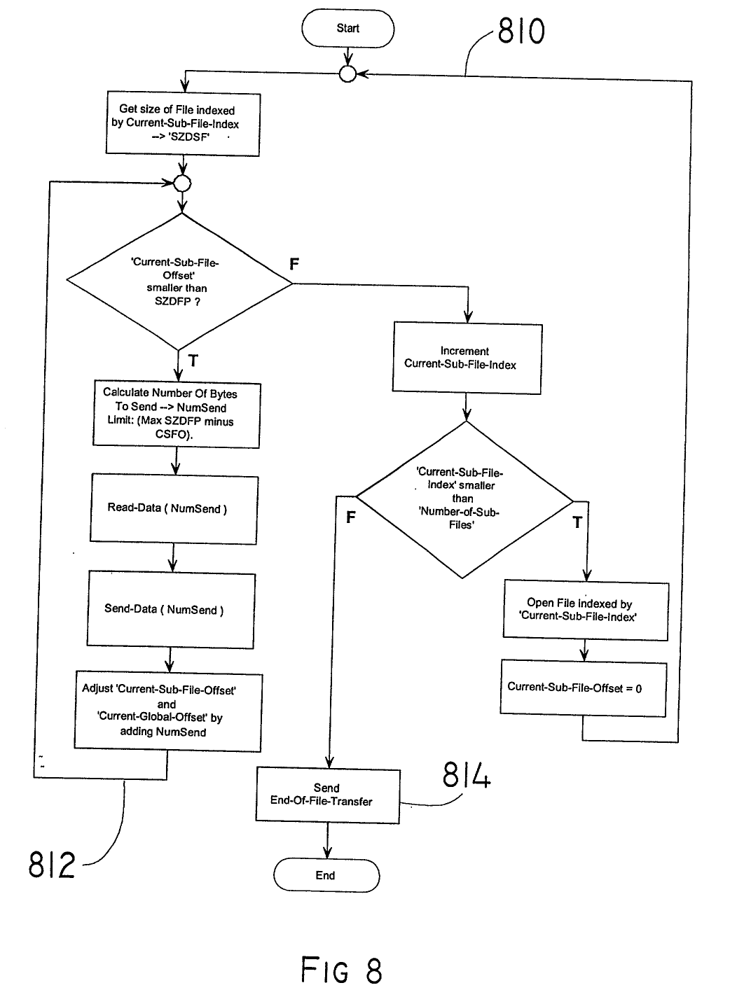

The data within the ‘dynamic file’ may be transferred to the client by a method illustrated in FIG. 8. An outer loop 810 selects each constituent sub-file in turn in order as per the database information. An inner loop 812 then sends the data to the client. Within the inner loop 812, the data may be realigned, reformatted or padded to suit the file format As each constituent file is completed, the next file is opened and to continue with the data transfer. Once the transfer is complete, an indicative signal is sent to the client (Step 814).

The dynamic file database performs additional functions within the system. The database keeps track of how much of the file has been downloaded for security, accounting and billing purposes, and also the creation date.

Accounting: The database keeps track of the number of full downloads and partial downloads of a virtual file. For example a user might download the first chapter of a book, listen to it and then decide not to download the rest of the book. The statistics for this could be gathered from the download database. They could be used, for example, to determine the most popular types of audio books and so that more of those could be recorded in the future.

Billing: When a download of a virtual file has been completed, then the additional content such as advertisements may be billed to the advertisers. (It may be that a partially-downloaded virtual file will not be billed in this way because it is unlikely that a partially-downloaded virtual file will be of much value to the user).

Changing contents: If a virtual file has never been downloaded (download count=0 and download_point=−1), its additional contents may still be changed. For example an advertisement may be replaced with revised text or it may have been removed (e.g. banned for non-payment by the advertiser). The additional contents of the virtual file could then be changed so that a user would download the new additional contents instead. This might be done without changing the length of the file by selecting new contents of the same or smaller length and appending blank data at the end of the file.

Security: Each time a virtual file is downloaded, the point at which the download is resumed and how many concurrent downloads from different network addresses may be used to check if the file have been made public. This is important if no additional contents such as advertisements are included. For example, a user may choose to subscribe with payment for advertisement-free content. These extra resume points and download counts can be use to detect illegal use of the unique references, such as those made public and accessed by many different network addresses and/or downloaded from the start or different points. This can be then used to deny access to these virtual file or files automatically or by issuing notices to the administrators that the files have been accessed illegally (and then can be removed to deny further access).

Creation Date: This is kept so that the file reference is only valid for a specific limited time (e.g. 2 months). Content that is time-related can be removed before it becomes irrelevant.

The final format of the download delivered to the client can adopt various formats. For example:

1. A very large MP3 file:

(Advertisements+Chapter1+Advertisements+Chapter2 . . . ID3Tag). This may not be preferred by some users where the requested content is an audio book because not that useful as most books are read/listened to by the chapter. Such a large file is also difficult to navigate, so a user is likely to “loose their place” in the book.

2. A set of smaller files consisting of chapters with advertisements: File1 :

(Advertisements+Chapter1+ID3Tag); File2: (Advertisements+SmallChapter2+Advertisements+SmallChapter3+ID3Tag); . . . FileN:

(Advertisements+LastChapter+ID3Tag).

3. A single archive (e.g. ZIP format as it is well known and used) FILE.ZIP that contains File1: (Advertisements+Chapter1+ID3Tag); File2: (Advertisements+SmallChapter2+Advertisements+SmallChapter3+ID3Tag); . . . FileN:

(Advertisements+LastChapter+ID3Tag).

If a user wants the whole book as a single file (to listen to in one session), s/he would typically choose method 1. If the user wants to download and listen to the first chapter before s/he downloads the rest of the book s/he might typically select method 2. If the user wants to download the book in an archive which will extract the files as smaller, easier-to-use chapters s/he will typically use method 3.

In order to make clear the advantage of this embodiment in a system that provides a service that provides users with audio books, consider the following table. This compares the storage requirements of a server being a system embodying the invention as compared with a server that maintains all required files as conventional files.

| | | | | |
|---|---|---|---|---|
| Number of Users: | 1,000,000 | 1,000,000 | 1,000,000 | 1,000,000 |
| Number of downloads per year per user: | 20 | 20 | 20 | 20 |
| Number of downloads per year: | 20,000,000 | 20,000,000 | 20,000,000 | 20,000,000 |
| Average number of users downloading | 54,795 | 54,795 | 54,795 | 54.795 |
| files per day | | | | |
| Average size of 1 download | 64 MB | 128 MB | 256 MB | 512 MB |
| Total size of files selected (all unique) | 3,506,849 MB | 7,013,699 MB | 14,027,397 MB | 28,054,795 MB |
| for download in 1 day | | | | |
| min. period we have to maintain the | 30 days | 30 days | 30 days | 30 days |
| temporary file so user can “PAUSE” and | | | | |
| “RESUME” his Downloading Manager | | | | |
| Conventional Server | | | | |
| Download storage size of current and | 105,205,479 MB | 210,410,959 MB | 420,821,918 MB | 841,643,836 MB |
| existing files (including those not | | | | |
| completely downloaded yet (1)) | | | | |
| (1) in Gigabytes | 105,205 GB | 210,411 GB | 420,822 GB | 841,644 GB |
| (1) in Terabytes | 105 TB | 210 TB | 421 TB | 842 TB |
| Large High performance hard disk drive size | 36 GB | 36 GB | 36 GB | 36 GB |
| Number of above size hard disk drives | 2,923 | 5,845 | 11,690 | 23,379 |
| needed to store this | | | | |
| Cost per drive | $800 | $800 | $800 | $800 |
| | $2,338,400 | $4,676,000 | $9,352,000 | $18,703,200 |
| Number of disk controllers needed | 488 | 975 | 1,949 | 3,897 |
| Cost per controller | $600 | $600 | $600 | $600 |
| | $292,800 | $585,000 | $1,169,400 | $2,338,200 |
| Total cost of storage | $2,631,200 | $5,261,000 | $10,521,400 | $21,041,400 |
| NOTE: The above cost excludes server | | | | |
| memory needed to cache file access | | | | |
| tables; cost of hosting; networking; | | | | |
| maintenance; IP addresses etc. | | | | |
| Server embodying the invention | | | | |
| Average database record per file | 100 KB | 100 KB | 100 KB | 100 KB |
| in MB | 0.10 MB | 0.10 MB | 0.10MB | 0.10MB |
| Average database record size for files per | 164,384 MB | 164,384 MB | 164,384 MB | 164,384 MB |
| days needed to download | | | | |
| in GB | 164 GB | 164 GB | 164 GB | 164 GB |
| Number of drives to store custom | | | | |
| download files | 5 | 5 | 5 | 5 |
| Number of disk controllers needed | 1 | 1 | 1 | 1 |
| Total cost of storage | $4,600 | $4,600 | $4,600 | $4,600 |
| Savings: | $2,626,600 | $5,256,400 | $10,516,800 | $21,036,800 |
| | 99.83% | 99.91% | 99.96% | 99.98% |
| | 572 times | 1,144 times | 2,287 times | 4,574 times |

It will be noted in the above table that, although the size of the content may increase (for example if higher quality content is provided, for example at a higher bit rate, or with video or other content) the database requirements do not change correspondingly. The example of 100 KB per record is in practice more than ample to manage files of the sizes indicated and larger and in fact could be condensed if storage space were critical.

It is noted that the additional content may comprise pre-existing files or files or other resources (for example, an advertisement dynamically created for the user using partially pre-recorded content and speech synthesis).

It will be understood that the present invention has been described above purely by way of example, and modifications of detail can be made within the scope of the invention.

Each feature disclosed in the description, and (where appropriate) the claims and drawings may be provided independently or in any appropriate combination.

Reference numerals appearing in the claims are by way of illustration only and are intended to have no limiting effect on the scope of the claims.

What is claimed is:

1. A file transfer method comprising:
receiving at a server a request from a client for a file, and
wherein in response to a request to download the requested file, the server supplying one or more data segments which data segments together constitute content of the requested file and additional content selected for the user.

2. A file transfer method according to claim 1 in which the segments comprise a virtual file reference which corresponds to the requested file and additional content selected for the user.

3. A file transfer method according to claim 1 or claim 2 further comprising, at the client, operating a download manager to arrange the segments supplied from the server to form a complete file.

4. A file transfer method according to claim 1 in which the file requested by the client includes encoded audio information.

5. A file transfer method according to claim 1 in which the additional content is provided in a format identical to or compatible with the content of the file requested by the client.

6. A file transfer method according to claim 5 in which the segments are provided to the client in a format which appears to constitute a unified file.

7. A file transfer method according to claim 1 in which supplying the segments includes applying a data compression algorithm to the contents of the file in the course of forming the segments.

8. A file transfer method according to claim 7 further comprising the client uncompressing the segment contents to restore them to their original format.

9. A file transfer method according to claim 1 further comprising the server identifying the user of the client and selecting the additional content according to known information relating to the user.

10. A file transfer method according to claim 9, wherein said information is personal information provided by the user prior to the user making the file transfer request.

11. A file transfer method according to claim 9 further comprising the server requesting the user to complete a questionnaire soliciting personal information and selecting the additional content responsive to the supplied personal information.

12. A file transfer method according to claim 9, further including storing the personal information in a user database for future retrieval.

13. A file transfer method according to claim 1 in which the server receives a request from the client, and the server assigns the request a unique request identifier.

14. A file transfer method according to claim 13, further including storing a record of the request in a database, the record being identified by the request identifier.

15. A file transfer method according to claim 14, further including constructing from the unique identifier a virtual URL from which a file containing the data segments and additional content can be downloaded by the client.

16. A file transfer method according to claim 15, further including the server transmitting the virtual URL to the client.

17. A file transfer method according to claim 15, further including the client using part of the virtual URL as a local file store name for the downloaded file

18. A file transfer method according to claim 17 in which the virtual URL includes a name of an audio file.

19. A file transfer method according to claim 15 in which the virtual URL includes data to enable the client to perform error detection on the downloaded file.

20. A file transfer method according to claim 1, further including processing the segments prior to supplying them to the client to bring said segments into accordance with a requested file specification.

21. A file transfer method according to claim 1, further including, when a transfer is interrupted and subsequently resumed, on resumption, the server supplying to the client only those segments not previously supplied to the client.

22. A file transfer method according to claim 21, further comprising the server assembling the data segments and additional content into a virtual file and the server keeping a record of the position in the virtual file to which a download has progressed to a point of interruption, and, upon resumption, server re-starting the download from that position.

23. A file transfer method according to claim 1 in which the server supplies data segments to the client in a discontinuous stream.

24. A file transfer method according to claim 23 in which there are one or more pauses in the stream within or between segments.

25. A file transfer method according to claim 1, further including the client storing the received data on a data carrier.

26. A file transfer method according to claim 25, further including conveying the data carrier to a user.

27. A file transfer method according to claim 25, further including downloading said data segments to a user's computing device.

28. A file transfer method according to claim 1, further including the server returning to the client a list of identifiers that identify segments to be downloaded in order to provide the content requested by the user, and the client subsequently requesting the segments specified in the list.

29. A file transfer method according to claim 28 in which the identifiers identify real files on the server.

30. A file transfer server system comprising a request receiver to receive a request for a file from a server, a store for storing content requested by a user and additional content, and an interface arranged to send to the client a plurality of data segments in turn that together constitute content of the requested file and additional content provided by the server.

31. A file transfer server system according to claim 30 in which the request receiver communicates with a client over a network link using a network protocol.

32. A file transfer server system according to claim 31 in which the network protocol is one of hypertext transfer protocol (HTTP), wireless application protocol (WAP) or file transfer protocol (FTP).

33. A file transfer server system according to any one of claims 30 to 32 in which the request receiver is embodied within a web server.

34. A file transfer server according to any one of claims 30 to 32 further comprising non volatile data storage for storing segments that constitute content of the requested file and additional content provided by the server on a data carrier.

35. A file transfer server according to claim 30 further comprising a data interface for transferring segments that constitute content of the requested file and additional content provided by the server to a user's computing device.

36. A file transfer server system according to claim 30 including a selection engine for selecting data specific for the client.

37. A file transfer server system according to claim 36 in which the selection engine includes a dynamic file database.

38. A file transfer server system according to claim 37 in which the dynamic file database contains a record for each request, the record identifying the data segments to be sent to the client in order to meet the request.

39. A file transfer server system according to claim 37 in which the data segments and additional content are arranged into a virtual file and wherein the dynamic file database contains a record for each request, the record indicating the position within the virtual file to which a client download has progressed.

40. A file transfer server system according to claim 30 including a user database.

41. A file transfer server system according to claim 40 in which the user database includes a list of users and personal information that relates to each user.

42. A file transfer server system according to claims 30 including a database server that manages at least one of the dynamic file database and the user database.

43. A file transfer server system according to claim 42 in which a selection engine is embodied within the database server.

44. A file transfer server system according to claim 30 wherein the data segments and additional content are arranged into a virtual file and the system returns to the client a virtual URL from which the virtual file can be downloaded by the client.

45. A file transfer server system according to claim 44 in which a request for data from the virtual URL is handled by a sending engine.

46. A file transfer server system according to claim 45 in which the sending engine is embodied within a file transfer server.

47. A file transfer server system according to claim 46 in which the file transfer server communicates with the client using one of hypertext transfer protocol (HTTP), wireless application protocol (WAP) or file transfer protocol (FTP).

48. A file transfer server system according to claim 30 in which the server returns to the client a list of identifiers that identify segments to be downloaded to provide the content requested by the user.

49. A file transfer server according to claim 48 in which the identifiers identify real files on the server.

50. A file transfer server system according to claim 30 embodied by a computer system executing server software.

51. A file transfer server system according to claim 30 that operates in accordance with a method of claim 1.

52. A computer program product comprising a computer-readable medium having encoded thereon instructions for server software executable on a computer system to perform a method of claim 1.

53. A download client comprising a computer system programmed to send a request to a file transfer server according to claim 30.

54. A method of operating a file transfer server to respond to a request for a file from a user, comprising receiving a request for a file and compiling a list of data segments to be sent in response to the request, which data segments together constitute content of the requested file and additional content provided by a service provider.

55. A method of operating a file transfer server according to claim 54 comprising identifying a user making the request and selecting segments based on the results of identifying the user.

56. A method of operating a file transfer server according to claim 55 in which, prior to responding to a file transfer request from a user, the server obtains personal information from the user, and that personal information is used order to determine the additional content to be sent to the user.

57. A method of operating a file transfer server according to claim 56 further including the server obtaining personal information by requesting the user complete a questionnaire.

58. A method of operating a file transfer server according to claim 56 or claim 57 further including storing the personal information in a user database for future retrieval.

59. A method of operating a file transfer server according to any one of claims 54 to 57 further including the server receiving requests from a client and returning data to the client using a network protocol.

60. A method of operating a file transfer server according to claim 59 in which the protocol is one of hypertext transfer protocol (HTTP), wireless application protocol (WAP) or file transfer protocol (FTP).

61. A method of operating a file transfer server according to claim 54 in which the server receives a request, and the server assigns the request a unique request identifier.

62. A method of operating a file transfer server according to claim 61 including constructing a record of the request in a database, the record being identified by the request identifier.

63. A method of operating a file transfer server according to claim 62 including using the unique identifier to construct a virtual URL from which the virtual file can be downloaded.

64. A method of operating a file transfer server according to claim 63 including the server returning the URL to a client.

65. A method of operating a file transfer server according to claim 64 in which the URL includes a name of an audio file.

66. A method of operating a file transfer server according to claim 63 in which the URL includes data to enable the client to perform error detection on the downloaded file.

67. A method of operating a file transfer server according to claim 55 comprising a further step of processing one or more data segments prior to them being sent to a client to bring them into accordance with a requested file specification.

68. A method of operating a file transfer server to claim 55 further comprising the server transferring the data segments to the user and, a client of when a transfer is interrupted and subsequently resumed, on resumption, sending only those segments not previously sent to the client are then sent to the client.

69. A method of operating a file transfer server according to claim 68 further comprising assembling the data segments, prior to sending, into a virtual file, and keeping a record of the position in the virtual file to which a download has progressed, and, upon resumption after interruption, re-starting the download from that position.

70. A method according to claim 1 wherein receiving requests includes receiving requests from a plurality of users and supplying includes the server supplying to the users in response to a request for a specified file data which differs between the users.

71. A method of storing and supplying data for a plurality of users, the method comprising storing at a server a virtual file reference for each user, the virtual file reference for each user corresponding to requested data and additional content selected for the user, the method comprising receiving at the server a file download request containing said virtual file reference from a user download client and supplying data corresponding to the virtual file reference to the user download client to form a contiguous real file, wherein the server does not store contiguous real files corresponding to at least some virtual file references.

72. A method according to claim 71, wherein the server constructs and stores a contiguous real file temporarily during an active download.

73. A method according to claim 71, further including the server responding to a download request by dynamically concatenating real file fragments.

74. The method according to claim 73 wherein concatenating is performed without constructing a contiguous real file on the server.

75. A method comprising allocating at a server a virtual file reference to a download request from a user, and mapping the virtual file reference to content selected for the user from among a plurality of available possible content resources available at the server and downloadable by the user as a complete file even if not stored on the server as a complete file.

76. A method of distributing requested information comprising receiving data identifying a requestor of the information and sending the information to the requestor along with additional content selected for the requestor on the basis of the data.

77. The method of claim 76 wherein sending includes sending an identifier of a virtual file stored on a server and retrieving from a server the virtual file using the virtual file identifier.

78. The method of claim 76 or 77 wherein the additional content comprises advertising.

79. The method of claim 78 wherein the advertising is embedded in the information sent.

80. The method of any of claims 76-79 wherein the information comprises an audio book.

81. The method of any of claims 76-79 wherein the information comprises an entertainment product.

82. The method of claim 81 wherein the entertainment product includes a MIME file.

83. The method of any of claims 76-79 wherein the information comprises one or more computer programs.

84. The method of any of claims 76-79 wherein the information comprises a primarily textual product.

85. The method of any of claims 76-79 wherein the information comprises an educational product.

86. The method of claim 76 or claim 77 wherein the data identifying a requestor includes preference data supplied by the requestor and the additional content comprises content selected to likely be of interest to individuals who provide similar preference data.

87. The method of claim 86 wherein the preference data is supplied before the request.

88. The method of claim 87 wherein the preference data is supplied along with the request.

89. A method of distributing advertising, comprising: receiving at a server a request from a client for a download of specified information; also receiving at the server profiling data characterizing a user of the client who issues the download request; analyzing the profiling data and selecting from among a plurality of available advertisements one or more advertisements that may be expected to appeal to an individual who has provided the profiling data; assembling the specified information and the specified information into a unitary download and providing to the client the unitary download.

90. The method of claim 89 wherein the unitary download is a virtual file assembled in response to, and at the time of, the client requesting said download.

91. The method of claim 90 further including providing to the client a download manager utility that resumes the download, following an interruption in the download process, at a point in the virtual file corresponding to the end of the portion of the virtual file already sent before said interruption.

92. The method of any of claims 89-91 further including billing a provider of an advertisement after it has been downloaded.

93. The method of any of claims 89-91 wherein an advertisement is an audio information stream when the specified information is audio information.
